(19) United States
(12) Patent Application Publication
(10) Pub. No.: US 2010/0071857 A1
(43) Pub. Date: Mar. 25, 2010

(54) Slider assembly for salt

(76) Inventor: Hans Hung, Foster City, CA (US)

Correspondence Address: Chiayuan Chang, 1217 Beach Park Blvd., Foster City, CA, 94404, US

(21) Appl. No.: 12/232,634

(22) Filed: Sep. 22, 2008

(51) Int. Cl. E06B 9/24

(52) U.S. Cl. 160/97

(57) ABSTRACT

A slider assembly includes an axle device having a base with an engaging member for coupling with another engaging member on a slat. The base includes an axle on a top thereof. The axle includes a top portion having a slit, forming two resilient tabs spaced by the slit. The axle further includes a bottom portion having an enlarged section. A slider includes a seat having a plurality of rollers rotatably mounted thereto. The seat includes an axle hole having a lower opening. The axle hole includes a retaining shoulder on an inner periphery thereof. The axle is inserted into the axle hole by resiliency provided by the slit. The enlarged section of the axle is engaged with the retaining shoulder, allowing the axle to rotate about an axis. The axle has a fixed position along the axis.

### BACKGROUND OF THE INVENTION

The present invention relates to a slider assembly for a slat and, more particularly, to a slider assembly that can move smoothly by utilizing a rotatable axle device.

Blinds can provide shield from sunlight, privacy, and decoration for buildings. A plurality of slats are required for a window having a larger area. To allow positioning of the slats in “open” or “closed” positions or a position therebetween, an engaging member (such as in the form of a hook) is provided on a top of each slat and engaged with another engaging member (such as in the form of a through-hole) of a slider assembly that is slideably received in a header having one ore more tracks in which two adjacent tracks are spaced by a rib having a lower end from which two track pieces respectively extending into the two adjacent tracks. The slider assembly slideably received in the track includes a plurality of rollers in rolling contact with two adjacent track pieces located in the track, thereby achieving operation of opening/closing and positional adjustment. However, the slider assembly is moved in a limited space, such that a periphery of the slider assembly is liable to be in contact with and hindered by two sidewalls of the track and the track pieces, leading to hindrance to the movement of the slider assembly and operation of opening/closing and positional adjustment of the slat.

Thus, a need exists for a slider assembly that can move smoothly to allow smooth movement of the slat.

### BRIEF SUMMARY OF THE INVENTION

The present invention solves this need and other problems in the field of blinds by providing, in a preferred form, a slider assembly including an axle device having a base with an engaging member adapted for coupling with another engaging member on a slat. The base includes an axle on a top thereof. The axle includes a top portion having a slit, forming two resilient tabs spaced by the slit. The axle further includes a bottom portion having an enlarged section. A slider includes a seat having a plurality of rollers rotatably mounted thereto. The seat includes an axle hole having a lower opening. The axle hole includes a retaining shoulder on an inner periphery thereof. The axle is inserted into the axle hole by resiliency provided by the slit. The enlarged section of the axle is engaged with the retaining shoulder, allowing the axle to rotate about an axis. The axle has a fixed position along the axis.

In the most preferred form, the base includes a top plate having two sides. The base further includes first and second legs respectively extending downward from the two sides. The engaging member is a through-hole defined in the second leg, and the other engaging member of the slat is a hook coupled with the through-hole.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a partial, perspective view of a header having a single track and a plurality of slider assemblies according to the preferred teachings of the present invention.

FIG. 2 shows a perspective view of a slider and an axle device of a slider assembly of FIG. 1.

FIG. 2A shows a partial, cross sectional view of the slider and the axle device of FIG. 2.

FIG. 3 is a partial, perspective view illustrating use of the slider assemblies according to the preferred teachings of the present invention with a header having a plurality of tracks and a slat.

FIG. 4 is a partial, perspective view illustrating use of the slider assemblies according to the preferred teachings of the present invention with a header having a plurality of tracks and a plurality of carriers.

FIG. 5 shows a partial, exploded, perspective view of the header, the carriers, and the slider assemblies of FIG. 4.

FIG. 6 is a side view of a carrier and two slider assemblies slideably mounted on the carrier.

FIG. 6A shows a partial, exploded, perspective view of the carrier and the slider assembly of FIG. 6.

FIG. 7 is a partial, perspective view illustrating use of the slider assemblies according to the preferred teachings of the present invention with a header having a plurality of tracks and a plurality of carriers each having a slat attached thereto.

FIG. 8 is a partial, perspective view illustrating use of the slider assemblies according to the preferred teachings of the present invention with a header having a plurality of tracks and a plurality of carriers each having a slat attached thereto by hook and loop fasteners.

FIG. 9 shows a top view of a header having a plurality of tracks, a plurality of carriers, and a plurality of slider assemblies according to the preferred teachings of the present invention.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

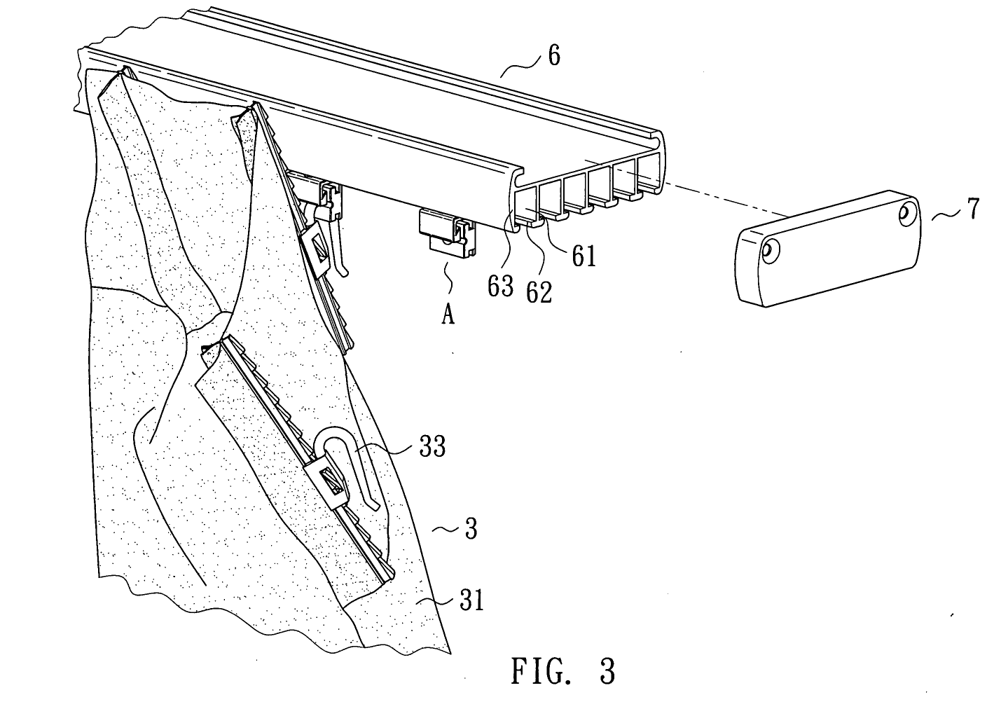

With reference to FIG. 3, a slider assembly A according to the preferred teachings of the present invention can be utilized with a header 6 for a blind 3. By coupling with a slat or shade 31 of blind 3 with slider assembly A, slat 31 can be moved along an extending direction of header 6 to achieve operation of opening/closing and positional adjustment.

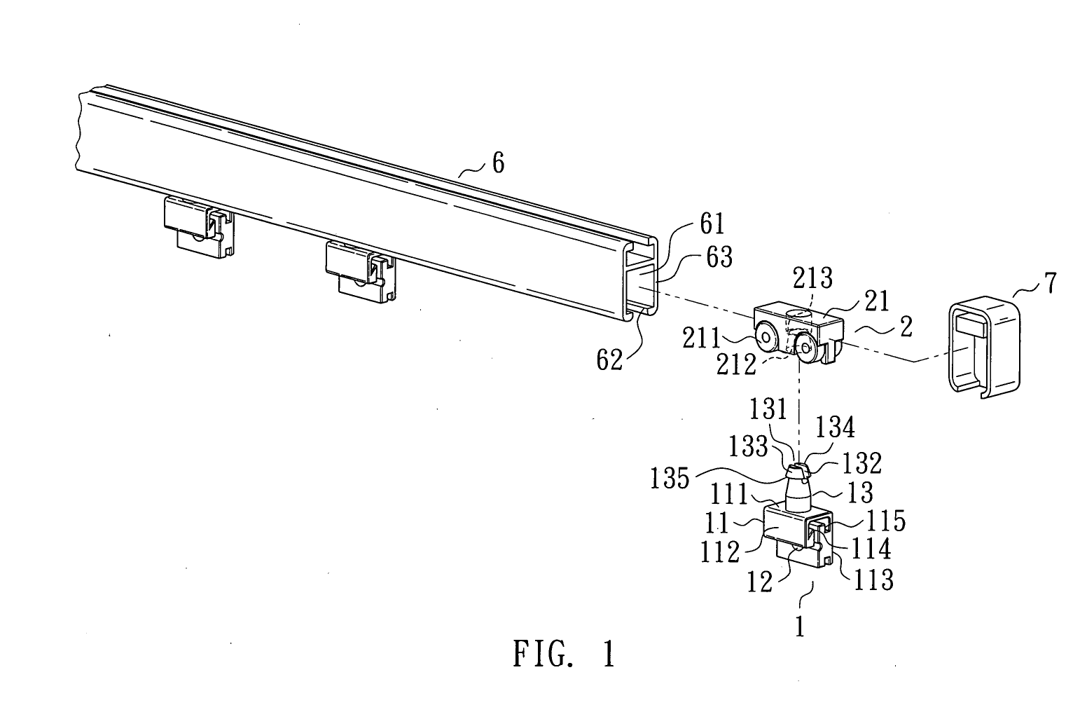

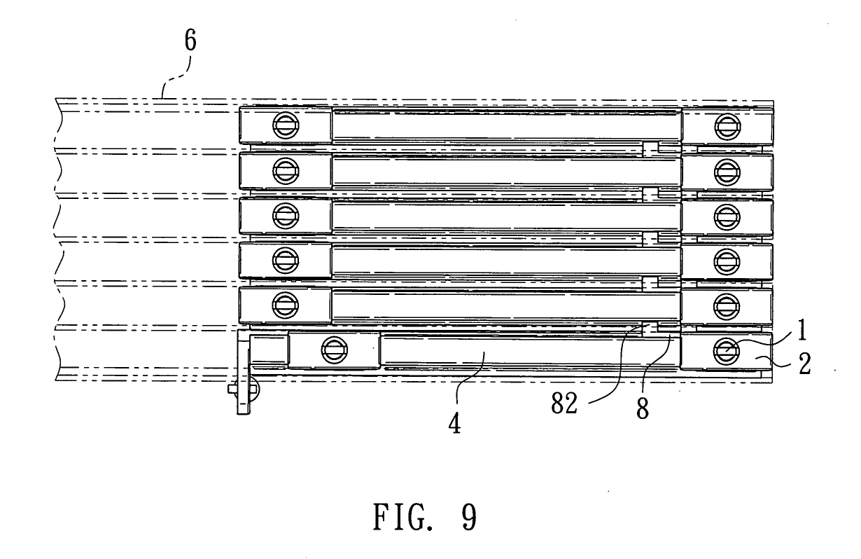

With reference to FIGS. 3 and 9, slider assembly A according to the preferred teachings of the present invention can be utilized with a header 6 having a plurality of tracks 61. Each track 61 includes two sidewalls 63 each having a track piece 62 extending into track 61. FIG. 1 shows a header 6 having a single track. To provide a neat appearance, an end cap 7 can be mounted to an end of header 6 shown in FIG. 1 or FIG. 3.

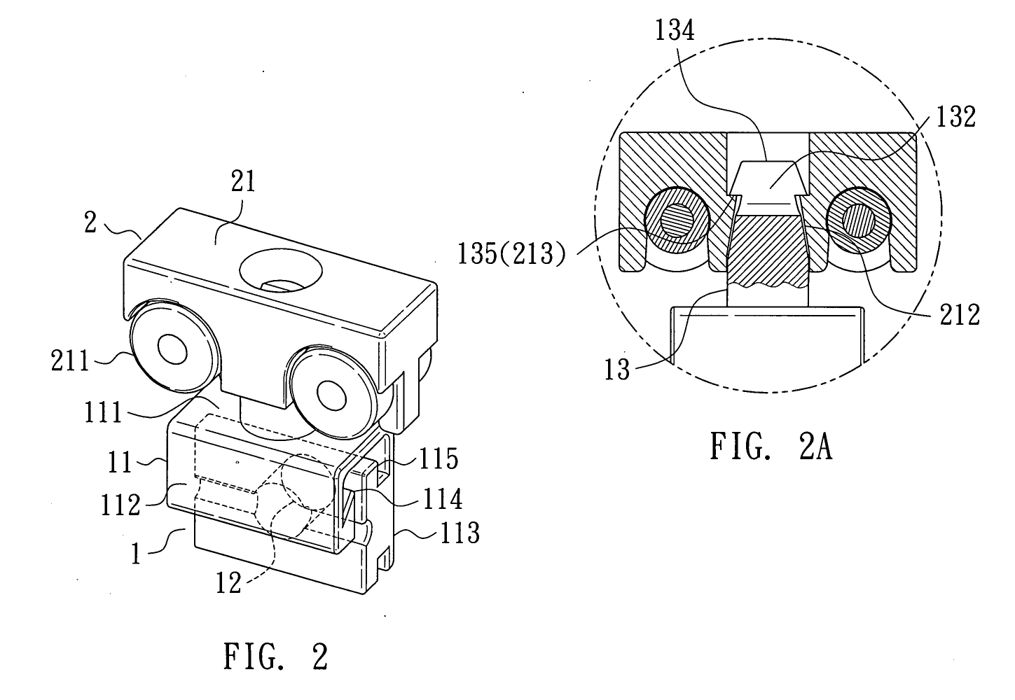

With reference to FIGS. 1, 2, 3, and 5, slider assembly A according to the preferred teachings of the present invention includes an axle device 1 having a base 11. Base 11 includes an engaging member 12 (in the preferred form shown as a through-hole) for coupling with another engaging member 33 (in the preferred form shown as a hook) of slat 31 of blind 3. An axle 13 is provided on a top of base 11 and includes a slit 132 defined in a top portion 131 thereof, forming two resilient tabs 133 and 134 spaced by slit 132. Top portion 131 of axle 13 includes an enlarged section 135 at a bottom portion thereof. Base 11 includes a top plate 111 from which axle 13 extends upward. Top plate 111 includes first and second legs 112 and 113 extending downward from two sides thereof. Engaging member 12 (through-hole) is formed on second leg 113. Second leg 113 is longer than first leg 112 to allow easy coupling. First leg 112 includes a hook 114 extending inward, and second leg 113 includes a hook 115 extending inward.

Slider assembly A according to the preferred teachings of the present invention further includes a slider 2 having a seat 21 to which a plurality of rollers 211 are rotatably mounted. Rollers 211 are mounted on and moveable along track pieces 62 of header 6 extending inward from sidewalls 63 of each track 61. Seat 21 includes an axle hole 212 having a lower opening. Axle hole 212 includes a retaining shoulder 213 on an inner periphery thereof. Axle 13 is forcibly inserted into axle hole 212 due to provision of resilient tabs 133 and 134 on top portion 131 of axle 13 until enlarged section 135 engages with retaining shoulder 213. After assembly, axle 13 can rotate freely about a vertical axis, and position of axle 13 along the vertical axis is fixed.

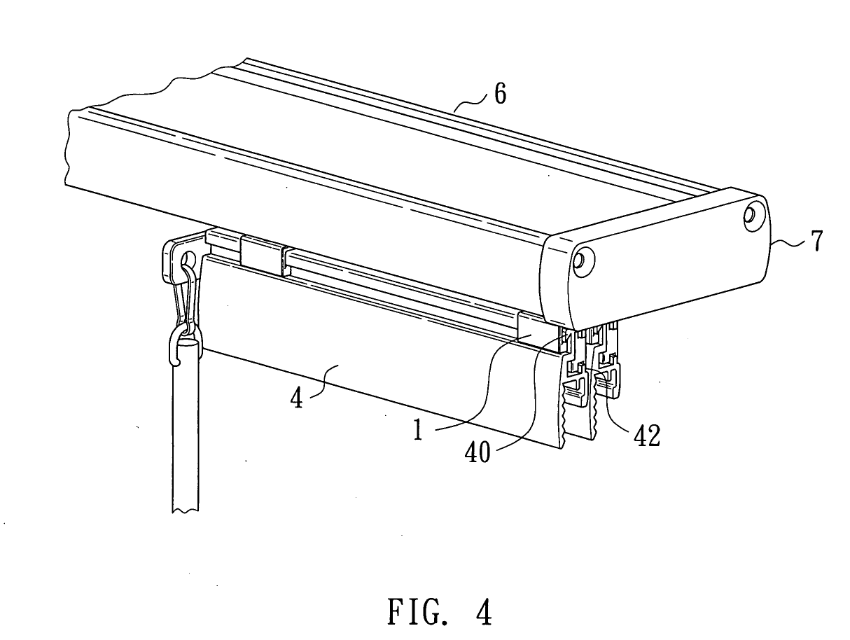

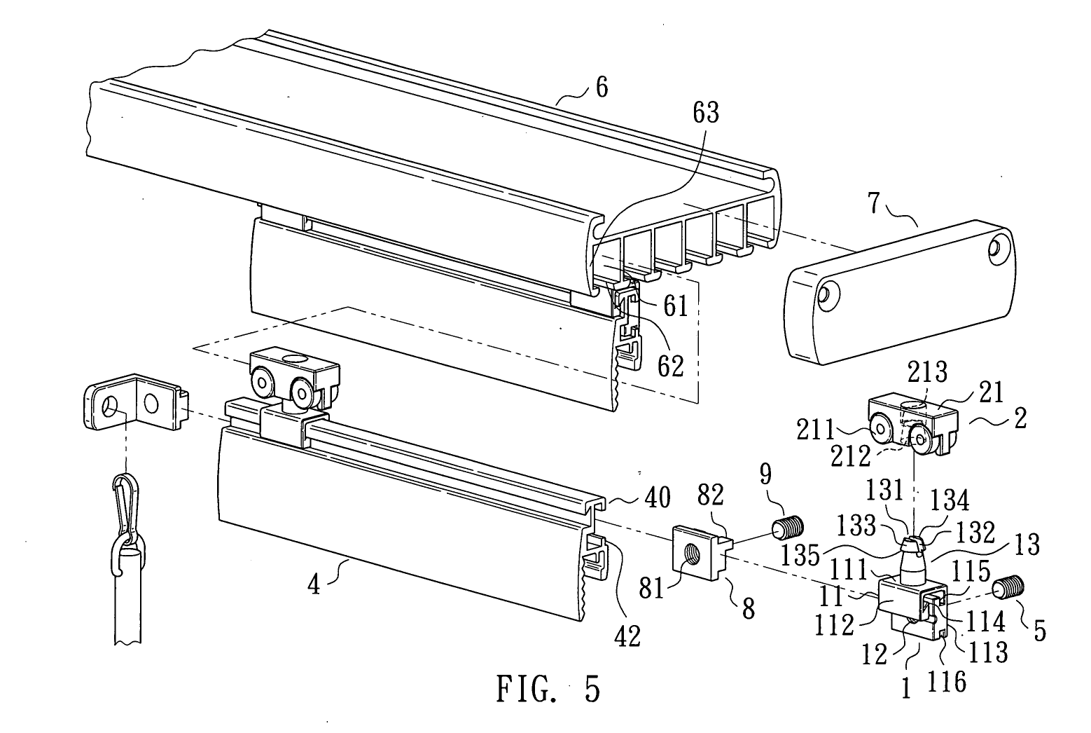

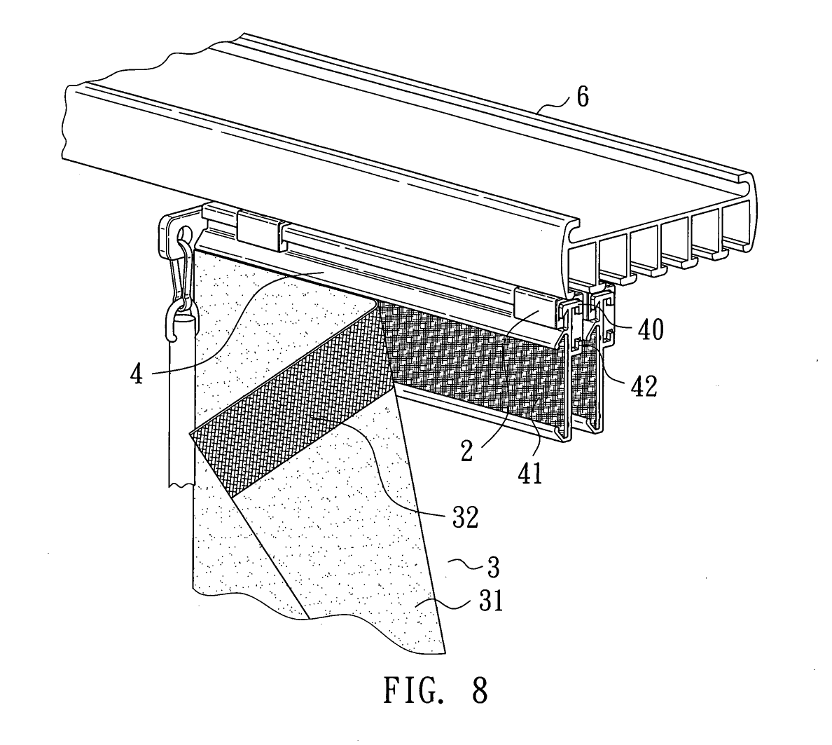

Slider assembly A according to the preferred teachings of the present invention can be utilized with carriers 4 shown in FIGS. 4 and 5. Specifically, two or more slider assemblies A according to the preferred teachings of the present invention is mounted on a carrier 4. Carrier 4 can include a plurality of hook fasteners 41 (FIG. 8), and slat 31 can include a plurality of loop fasteners 32 for coupling with hook fasteners 41. Carrier 4 has a width substantially the same as that of slat 31.

In use, the number of slats 31 is dependent upon the area to be covered by blind 3. Furthermore, a pressing block 8 (FIG. 5) can be provided to a side of slider assembly A according to the preferred teachings of the present invention. Pressing block 8 includes a screw hole 81. A screw 9 is extended through screw hole 81 to fix slider assembly A on carrier 4. Such an arrangement is suitable for a head 6 with a plurality of tracks 61. Particularly, pressing block 8 includes a pressing plate 82 extending therefrom. Pressing block 8 can push another carrier plate 4 in an adjacent track 61 to provide movement of carriers 4 as one. In a case that slider assembly A according to the preferred teachings of the present invention is utilized with such carriers 4, movement of carriers 4 extending across different tracks 61 can move smoothly without undesired shifting or hindrance due to free rotation of axle 13.

With reference to FIG. 5, carrier 4 includes a T-shaped section 40 at a top thereof. First and second legs 112 and 113 of base 11 of slider assembly A extend across two outer edges of T-shaped section 40. Furthermore, hook 114 of first leg 112 and hook 115 of second leg 113 couple with two sides of T-shaped section 40 to provide a reliable coupling. First leg 112 includes a downwardly facing groove 116 in a bottom thereof, and carrier 4 includes a corner piece 42 extending into and engaged in groove 116 to enhance the coupling effect.

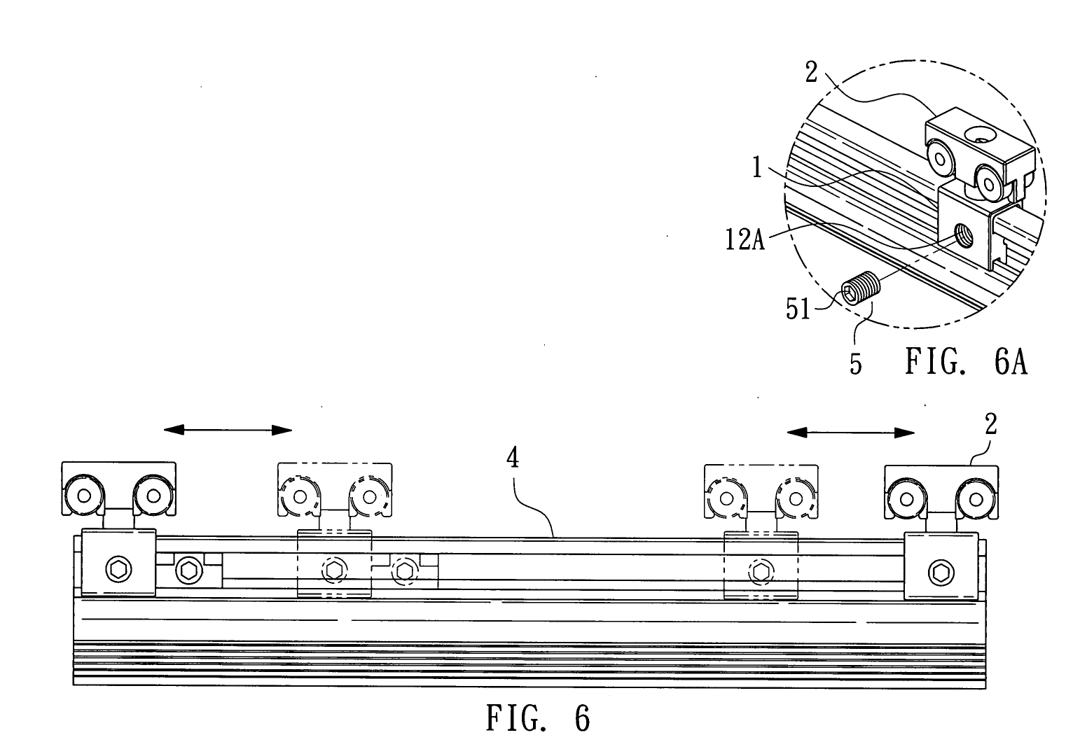

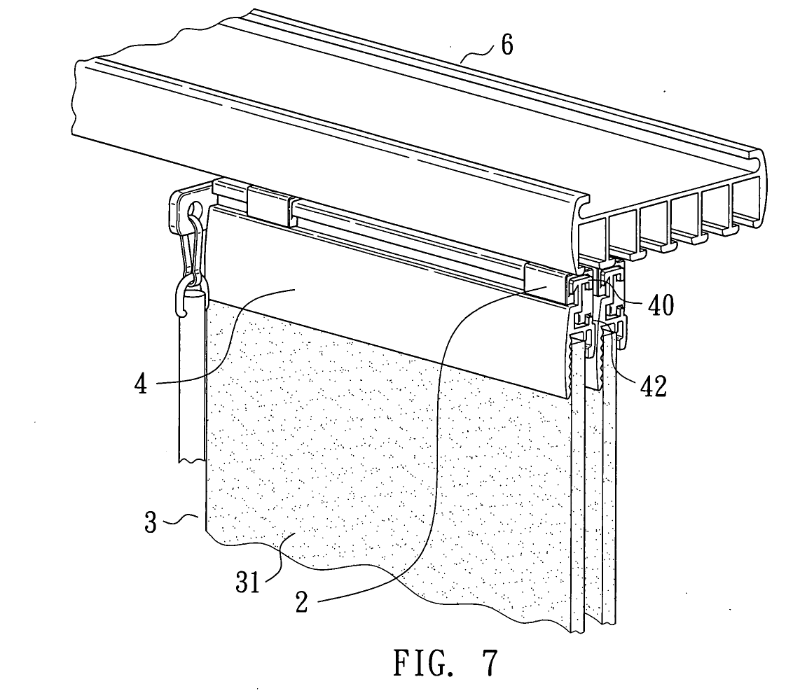

Since second leg 113 is longer than first leg 112, a screw 5 having a hexagonal groove 51 in an end face thereof can be inserted through engaging member 12 in the form of a screw hole 12A (FIG. 6) and tightened by a hexagonal wrench to an outer edge of T-shaped section 40 of carrier 4, providing a tight coupling. This also allows adjustment of position of slider assembly A relative to carrier 4 by loosening and then tightening screw 5.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A slider assembly for a slat comprising:
an axle device including a base having an engaging member adapted for coupling with another engaging member on the slat, with the base including an axle on a top thereof, with the axle including a top portion having a slit, forming two resilient tabs spaced by the slit, with the axle further including a bottom portion having an enlarged section; and
a slider including a seat having a plurality of rollers rotatably mounted thereto, with the seat including an axle hole having a lower opening, with the axle hole including a retaining shoulder on an inner periphery thereof, with the axle being inserted into the axle hole by resiliency provided by the slit, with the enlarged section of the axle engaged with the retaining shoulder, allowing the axle to rotate about an axis, and with the axle having a fixed position along the axis.

2. The slider assembly as claimed in claim 1, with the base including a top plate having two sides, with the base further including first and second legs respectively extending downward from the two sides, and with the engaging member being formed on the second leg.

3. The slider assembly as claimed in claim 2, with the engaging member of the axle device being a through-hole defined in the second leg, and with the other engaging member of the slat being a hook coupled with the through-hole.
